(19) United States
(12) Patent Application Publication
(10) Pub. No.: US 2026/0030068 A1
(43) Pub. Date: Jan. 29, 2026

(54) PREDICTIVE LOAD BALANCING AND THERMAL MANAGEMENT SYSTEM FOR DATA CENTERS

(71) Applicant: Dell Products L.P., Round Rock, TX (US)

(72) Inventor: Pankaj Pande, Carlingford (AU)

(21) Appl. No.: 18/787,054

(22) Filed: Jul. 29, 2024

(51) Int. Cl. G06F 9/50

(52) U.S. Cl. CPC G06F 9/5044; G06F 9/505; G06F 2209/5019; G06F 2209/508

(57) ABSTRACT

A method for managing a workload distribution includes: receiving a request including information associated with a workload; obtaining data of a set of IHSs; performing preprocessing on the data to obtain structured data; analyzing the structured data to identify a second set of IHSs; obtaining historical data associated with the second set of IHSs; making, based on the information, a first determination that the information does not include a geographic restriction; predicting, based on the structured data and historical data, a future state of each of the second set of IHSs; analyzing, based on the future health state of each of the second set of IHSs, the second set of IHSs to identify a third set of IHSs to deploy the workload; and deploying, based on the analyzing of the second set of IHSs, the workload to an IHS of the third set of IHSs.

### BACKGROUND

As the value and use of information continues to increase, individuals and businesses seek additional ways to process and store information. One option available to users (e.g., administrators) is information handling systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow IHSs to be general or configured for a specific user or a specific use such as financial transaction processing, airline ticket reservations, enterprise data storage, or global communications. Further, IHSs may include a variety of hardware and software components that may be configured to process, store, and communicate information and may include one or more computer systems, graphics interface systems, data storage systems, networking systems, and mobile communication systems. IHSs may also implement various virtualized architectures. Data and voice communications among IHSs may be via networks that are wired, wireless, or some combination.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example, and are not meant to limit the scope of the claims.

FIG. 1 shows a diagram of a system in accordance with one or more embodiments disclosed herein.

FIG. 2 shows a diagram of a management module in accordance with one or more embodiments disclosed herein.

FIGS. 3.1-3.3 show a method for managing workload distribution in accordance with one or more embodiments disclosed herein.

FIG. 4 shows an example use case in accordance with one or more embodiments disclosed herein.

FIG. 5 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, data centers, the backbone of the modern digital world, face technical challenges/limitations in maintaining efficient thermal management. Conventional approaches to manage thermal output of data centers are increasingly proving to be inadequate in the face of growing computational demands and environmental concerns. For example, in terms of reactive thermal management (which is one of the technical challenges), current data centers predominantly operate on a reactive basis, addressing thermal management issues as they arise. This approach is often inefficient and can lead to increased energy consumption, higher operational costs, and potential risks of overheating and system failures.

As yet another example, in terms of limited predictive capabilities (which is one of the technical challenges), existing solutions lack advanced predictive capabilities to foresee and adapt to future workload and thermal conditions. This limitation restricts the ability to optimize cooling resources proactively, leading to suboptimal thermal management and increased environmental impact.

As yet another example, in terms of geographical inefficiencies (which is one of the technical challenges), traditional methodologies do not fully leverage the potential benefits of distributing workloads across global data centers. This results in missed opportunities for utilizing cooler climates or regions with lower energy costs, thereby failing to optimize for global thermal efficiency.

As yet another example, from the perspective of a single-dimensional focus (which is one of the technical challenges), most thermal management strategies are primarily focused on maintaining temperature (of a data center) within safe limits. These strategies often overlook other critical performance metrics such as latency, throughput, and overall system resilience, which are crucial for the seamless operation of data centers.

For at least the reasons/challenges discussed above and without requiring resource-intensive efforts (e.g., time, engineering, etc.), a fundamentally different, more sophisticated approach/framework for workload balancing in data centers and thermal management of those data centers is needed (e.g., a framework that is proactive, predictive, and capable of optimizing data centers across multiple objectives (e.g., thermal efficiency, system performance, environmental impact, etc.) to address at least the aforementioned challenges).

Embodiments disclosed herein relate to methods and systems for managing workload balancing/distribution in data centers and thermal management of those data centers. As a result of the processes discussed below, one or more embodiments disclosed herein advantageously ensure that: (i) a predictive workload balancing and thermal management framework for optimizing the allocation of computational workloads in data centers is provided; (ii) for a better user/customer experience, with the help of the framework, an innovative approach to data center management (while focusing on, at least, proactive measures (e.g., based on forecasted thermal conditions, precooling an IHS/host/node (that is part of a data center); based on forecasted necessary computing resources to execute Workload T, migrating/redistributing Workload T (which is a compute-intense task) to another capable IHS in the data center considering external factors (e.g., regional weather conditions, legal constraints, etc.), global resource optimization, and environmental sustainability) is provided; (iii) an advanced predictive global workload distribution is performed across data centers (said another way, the framework (a) extends beyond current workload distribution solutions by employing a sophisticated predictive analytics approach that integrates long-term environmental forecasting with real-time IHS performance metrics and (b) uniquely applies the aforementioned data set globally, considering interrelated variables (holistically) such as regional energy costs, climate conditions, and geopolitical energy policies, which are not concurrently accounted for in existing solutions); (iv) unlike traditional systems that consider geographic data in isolation, the multidimensional analytical framework synthesizes disparate data streams and/or a wide array of variables (e.g., real-time environmental conditions, regional energy pricing, geopolitical considerations, renewable energy availability, etc.) in a way (a) to perform a more nuanced and environmentally conscious decision-making process that dynamically adapts to global shifts and (b) to prevent (or mitigate) potential inefficiencies in real-time; (v) the framework's predictive analytics capabilities extend beyond simple IHS workload and power consumption predictions, where the framework (a) anticipates global changes in energy costs, environmental policies, and even regional climate conditions to optimize workload distribution in real-time, and (b) leverages lower energy costs or cooler climates available in different regions (to significantly enhance energy efficiency and sustainability on a global scale); (vi) the framework is designed to dynamically recalibrate workload distribution and thermal management strategies in response to continuous real-time feedback (for example, from administrators), where the framework not only considers immediate IHS conditions (e.g., in order to be operational, IHS A needs X amount of cooling capacity, 85% central processing unit (CPU) utilization, etc.) but also adjusts its optimization parameters based on predictive analytics (to perform an effectively evolving and adaptive decision-making process in data center operations); (vii) the framework not only react to immediate changes (in data center operations) but also anticipate future adjustments (in those operations) in order to optimize both short-term and long-term objectives of a related organization, where the framework's use of reinforcement learning goes beyond conventional feedback mechanisms by generating an adaptive learning approach that continuously evolves its optimization strategies based on real-time operational feedback and external environmental changes; (viii) the framework is uniquely designed to balance complex objectives (e.g., minimizing energy consumption, optimizing thermal efficiency, ensuring high system performance, etc.) while dynamically adapting to real-time feedback, where the framework can recalibrate optimization strategies in response to changing data center conditions (e.g., available data center resources) and operational goals (so that the framework will have a high degree of adaptability and foresight in managing multiple objectives in real-time); (ix) the framework integrates advanced environmental forecasting, predicting not just data center (or IHS) specific metrics but also incorporating wider environmental and economic factors (where this level of predictive insight enables more strategic, environmentally sustainable decisions that are not confined to the immediate operational context (of data centers/IHSs) but consider broader impacts); (x) the framework combines global optimization goals with the capability for local adaptation, allowing data centers to not only contribute to overall network efficiency but also to respond dynamically to local conditions and constraints (where this dual-level optimization strategy ensures both global efficiencies and local operational excellence across data centers); (xi) the framework can be seamlessly integrated into existing data center infrastructures (e.g., the framework can be tailored to different data center scales and configurations, ensuring wide applicability and scalability); (xii) by predicting and proactively managing thermal conditions, the framework enables IHSs to operate more efficiently (while reducing the risk of overheating and system failures); (xiii) for a better user experience, the framework provides energy and cost savings (where the framework's optimal workload distribution and cooling strategies lead to significant reductions in an IHS' (or a data center's) energy consumption and operational costs), in which reduced energy consumption directly translates to a lower carbon footprint, aligning data center operations with environmental sustainability goals; and/or (xiv) the framework ensures that data centers are not just thermally efficient but also maintain high performance and reliability standards.

The following describes various embodiments disclosed herein.

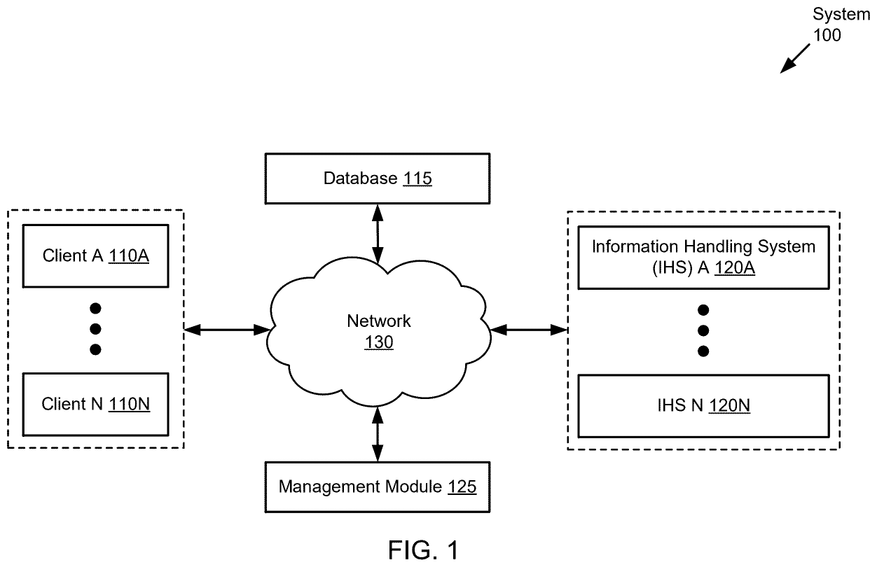

FIG. 1 shows a diagram of a system (100) in accordance with one or more embodiments disclosed herein. The system (100) includes any number of clients (e.g., Client A (110A), Client N (110N), etc.), a management module (125), a database (115), a network (130), and any number of data centers (not shown) (where each data center may include/host any number of IHSs (e.g., IHS A (120A), IHS N (120N), etc.)). In one or more embodiments, any number of IHSs that are deployed to (or considered as part of) a data center may collectively be referred to as “components of the data center”. The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the clients (e.g., 110A, 110N, etc.), the management module (125), the database (115), the IHSs (e.g., 120A, 120N, etc.), and the network (130) may be (or may include) physical hardware or logical devices, as discussed below. While FIG. 1 shows a specific configuration of the system (100), other configurations may be used without departing from the scope of the embodiments disclosed herein. For example, although the clients (e.g., 110A, 110N, etc.) and the IHSs (e.g., 120A, 120N, etc.) are shown to be operatively connected through a communication network (e.g., 130), the clients (e.g., 110A, 110N, etc.) and the IHSs (e.g., 120A, 120N, etc.) may be directly connected (e.g., without an intervening communication network).

Further, the functioning of the clients (e.g., 110A, 110N, etc.) and the IHSs (e.g., 120A, 120N, etc.) is not dependent upon the functioning and/or existence of the other components (e.g., devices) in the system (100). Rather, the clients (e.g., 110A, 110N, etc.) and the IHSs (e.g., 120A, 120N, etc.) may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

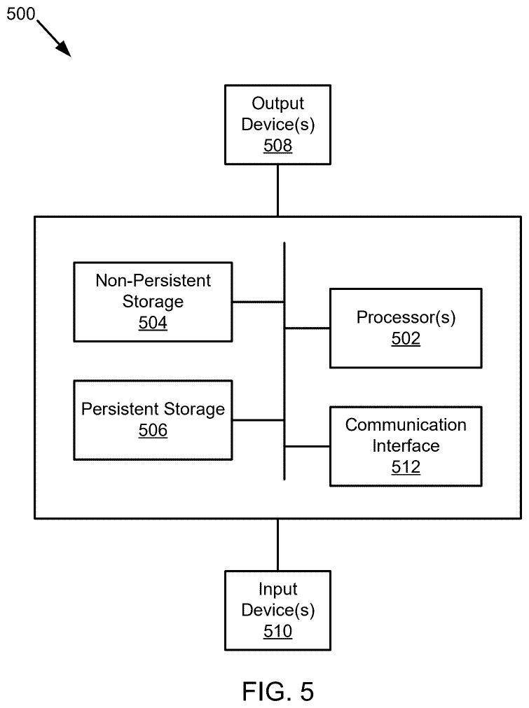

In one or more embodiments, the system (100) may be a distributed system (e.g., a data processing environment, a hybrid public-private computing environment, etc.) and may deliver at least computing power (e.g., real-time (on the order of milliseconds (ms) or less) network monitoring, server virtualization, etc.), storage capacity (e.g., data backup), and data protection (e.g., software-defined data protection, disaster recovery, etc.) as a service to users of clients (e.g., 110A, 110N, etc.). For example, the system may be configured to organize unbounded, continuously generated data into a data stream. The system (100) may also represent a comprehensive middleware layer executing on computing devices (e.g., 500, FIG. 5) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users' site using the clients (e.g., 110A, 110N, etc.)) and other computations remotely (e.g., away from the users' site using the IHSs (e.g., 120A, 120N, etc.)) from the users. By doing so, the users may utilize different computing devices (e.g., 500, FIG. 5) that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IOT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the IHSs (e.g., 120A, 120N, etc.)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to an IHS (e.g., 120A). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored to storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with an IHS (e.g., 120A). For example, the clients may issue requests to the IHS to receive responses and interact with various components of the IHS. The clients may also request data from and/or send data to the IHS (for example, the clients may transmit information to the IHS that allows the IHS to perform computations, the results of which are used by the clients to provide services to the users). As yet another example, the clients may utilize computer-implemented services provided by the IHS. When the clients interact with the IHS, data that is relevant to the clients may be stored (temporarily or permanently) in the IHS.

In one or more embodiments, a client (e.g., 110A, 110N, etc.) may be capable of, e.g.,: (i) collecting users' inputs, (ii) correlating collected users' inputs to the computer-implemented services to be provided to the users, (iii) communicating with an IHS (e.g., 120A) that perform computations necessary to provide the computer-implemented services, (iv) using the computations performed by the IHS to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IHS (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a CPU, a graphics processing unit (GPU), a data processing unit (DPU), a computation acceleration resource, an application-specific integrated circuit (ASIC), a digital signal processor for facilitating high-speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), RAM, Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., 120A, 120N, etc.) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8GB of PMEM and 1 CPU with 16 cores. Other different computational capabilities of the clients not listed above may also be taken into account without departing from the scope of the embodiments disclosed herein.

Further, in one or more embodiments, a client (e.g., 110A) may be implemented as a computing device (e.g., 500, FIG. 5). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored to the persistent storage, that when executed by the processor(s) of the computing device cause the computing device to perform the functionality of the client described throughout the application.

Alternatively, in one or more embodiments, the client (e.g., 110A) may be implemented as a logical device (e.g., a VM). The logical device may utilize the computing resources of any number of computing devices to provide the functionality of the client described throughout this application.

In one or more embodiments, users (e.g., customers, administrators, people, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing the virtualization technology. In one or more embodiments, an administrator may be a user with permission (e.g., a user that has root-level access) to make changes on the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 500, FIG. 5) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, a data center (with its components such as IHSs) may be configured for hosting and maintaining various workloads, and/or for providing a computing environment (e.g., computing power and storage) whereon workloads may be implemented. In general, a data center's infrastructure is based on a network of computing and storage resources that enable the delivery of shared application data. For example, a data center of an organization may exchange data with other data centers of the same organization registered in/to the network (130) in order to participate in a collaborative workload placement.

In one or more embodiments, a data center may be a part of a business operation region (BOR) (not shown) of an organization, in which the BOR may correspond to a geographic region/zone (e.g., a city, a county, a state, a province, a country, a country grouping (e.g., the European Union), etc.). For example, Data Center A of Organization X may be located in the United States and another Data Center C of Organization X may be located in the Netherlands, in which Organization X has multiple geographically distributed data centers around the world.

In one architecture (e.g., the “unidirectional” architecture), one of the data centers (e.g., a parent data center) of an organization may be deployed to the United States, which serves/shares data to/among the remaining data centers (e.g., child data centers that are deployed to Argentina, India, and France) of the organization. In this architecture, the child data centers may transmit their data to the parent data center so that the parent data center is always updated. Thereafter, the parent data center may distribute/forward received data to the child data centers to keep the child data centers equally updated.

In another architecture (e.g., the “bidirectional” architecture), one of the data centers of an organization may be deployed to Greece and the other one may be deployed to Spain, in which both data centers know each other and when a data change is occurred in one of them, the other data center may automatically obtain that data to stay updated. Further, in another architecture (e.g., the “multidirectional” architecture), an organization may have multiple data centers deployed around the world and all of the data centers know each other. When one of the data centers is updated (e.g., when that data center receives a software package), the remaining data centers are updated accordingly (e.g., by sending a data transfer request to each of the remaining data centers).

In one or more embodiments, an IHS (e.g., 120A) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, an IHS (e.g., 120A) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the database (115) for management of the data and/or for storage of the data (while pushing the data, the IHS may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or machine learning (ML) models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IHS (e.g., 120N) for review and/or other human interactions; (x) exchange data with other devices registered in/to the network (130) in order to, for example, participate in a collaborative workload placement (e.g., the IHS may split up a request (e.g., an operation, a task, an activity, etc.) with another IHS, coordinating its efforts to complete the request more efficiently than if the IHS had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to the database; (xv) provide (e.g., via a broadcast, multicast, or unicast mechanism) information (e.g., a location identifier, the amount of available resources, etc.) associated with the IHS to other IHSs of the system (100); (xvi) configure or control any mechanism that defines when, how, and what data to provide to the clients and/or database; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., the IHS may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IHS may communicate with, for example, the database and/or other storage devices in the system (100).

As described above, an IHS (e.g., 120A) may be capable of providing a range of functionalities/services to the users of the clients (e.g., 110A, 110N, etc.). However, not all of the users may be allowed to receive all of the services. To manage the services provided to the users of the clients, a system (e.g., a service manager) in accordance with embodiments disclosed herein may manage the operation of a network (e.g., 130), in which the clients are operably connected to the IHS. Specifically, the service manager (i) may identify services to be provided by the IHS (for example, based on the number of users using the clients) and (ii) may limit communications of the clients to receive IHS provided services.

For example, the priority (e.g., the user access level) of a user may be used to determine how to manage computing resources of the IHS to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IHS (e.g., while the computing resources of the IHS may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high-priority user (e.g., a privileged user, a user with a user access level of 9/10). In such a case, the user level of that user may indicate that more ports are to be opened than were for the first user so that (i) the IHS may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, OS data, etc.), medium workloads with higher priority (e.g., VM with FS data, network data management protocol (NDMP) data, etc.), large workloads with critical priority (e.g., mission critical application data), etc.

Further, while a single IHS (e.g., 120A) is considered above, the term “IHS” includes any collection of systems or sub-systems that individually or jointly execute a set, or multiple sets, of instructions to provide one or more computer-implemented services. For example, a single IHS may provide a computer-implemented service on its own (i.e., independently) while multiple other IHSs may provide a second computer-implemented service cooperatively (e.g., each of the multiple other IHSs may provide similar and or different services that form the cooperatively provided service).

As described above, an IHS (e.g., 120A) may provide any quantity and any type of computer-implemented services. To provide computer-implemented services, the IHS may be a heterogeneous set, including a collection of physical components/resources configured to perform operations of the IHS and/or otherwise execute a collection of logical components/resources of the IHS.

In one or more embodiments, a “computing” resource (e.g., a measurable quantity of a compute-relevant resource type that may be requested, allocated, and/or consumed) may be (or may include), for example (but not limited to): a CPU, a GPU, a DPU, memory, a network/networking resource, storage space (e.g., to store any type and quantity of information), storage input/output, a hardware resource set, a compute resource set (e.g., one or more processors, processor dedicated memory, etc.), a control resource set, etc.

In one or more embodiments, resources (or computing resources) of an IHS (e.g., 120A) may be divided into three logical resource sets: a compute resource set, a control resource set, and a hardware resource set. Different resource sets, or portions thereof, from the same or different IHSs may be aggregated (e.g., caused to operate as a computing device) to instantiate a composed IHS having at least one resource set from each set of the three resource set model.

In one or more embodiments, a hardware resource set (e.g., of an IHS) may include (or specify), for example (but not limited to): a configurable CPU option (e.g., a valid/legitimate vCPU count per-IHS option), a minimum user count per-IHS, a maximum user count per-IHS, a configurable network resource option (e.g., enabling/disabling single-root input/output virtualization (SR-IOV) for specific IHSs), a configurable memory option (e.g., maximum and minimum memory per-IHS), a configurable GPU option (e.g., allowable scheduling policy and/or vGPU count combinations per-IHS), a configurable DPU option (e.g., legitimacy of disabling inter-integrated circuit (I2C) for various IHSs), a configurable storage space option (e.g., a list of disk cloning technologies across all IHSs), a configurable storage input/output option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QOS) template, a 10 GB/s BW with 10 ms latency QoS template, etc.), a DPU related template (e.g., a 1 GB/s BW vDPU with 1 GB vDPU frame buffer template, a 2 GB/s BW vDPU with 1 GB vDPU frame buffer template, etc.), a GPU related template (e.g., a depth-first vGPU with 1 GB vGPU frame buffer template, a depth-first vGPU with 2 GB vGPU frame buffer template, etc.), a storage space related template (e.g., a 40 GB SSD storage template, an 80 GB SSD storage template, etc.), a CPU related template (e.g., a 1 vCPU with 4 cores template, a 2 vCPUs with 4 cores template, etc.), a memory related template (e.g., a 4 GB DRAM template, an 8 GB DRAM template, etc.), a speed select technology configuration (e.g., enabled, disabled, etc.), a virtual NIC (vNIC) count per-IHS, a wake on LAN support configuration (e.g., supported/enabled, not supported/disabled, etc.), a swap space configuration per-IHS, a reserved memory configuration (e.g., as a percentage of configured memory such as 0-100%), a memory ballooning configuration (e.g., enabled, disabled, etc.), a vGPU count per-IHS, a type of a vGPU scheduling policy (e.g., a “fixed share” vGPU scheduling policy, an “equal share” vGPU scheduling policy, etc.), a type of a GPU virtualization approach (e.g., graphics vendor native drivers approach such as a vGPU), a storage mode configuration (e.g., an enabled high-performance storage array mode, a disabled high-performance storage array mode, an enabled general storage (i.e., co-processor) mode, a disabled general storage mode, etc.), a backup frequency (e.g., hourly, daily, monthly, etc.), a hardware virtualization configuration, etc.

In one or more embodiments, a control resource set (e.g., of an IHS) may facilitate formation of composed IHSs. To do so, a control resource set may prepare any quantity of computing resources from any number of hardware resource sets (e.g., of the corresponding IHS and/or other IHSs) for presentation. Once prepared, the control resource set may present the prepared computing resources as bare metal resources to an orchestrator (not shown). By doing so, a composed IHS may be instantiated.

To prepare the computing resources of the hardware resource sets for presentation, the control resource set may employ, for example, virtualization, indirection, abstraction, and/or emulation. These management functionalities may be transparent to applications hosted by the resulting composed IHS (e.g., thereby relieving those applications from workload overhead). Consequently, while unknown to components of a composed IHS, the composed IHS may operate in accordance with any number of management models thereby providing for unified control and management of the composed IHS.

In one or more embodiments, the orchestrator may implement a management model to manage computing resources (e.g., computing resources provided by one or more hardware components/devices of IHSs) in a particular manner. The management model may give rise to additional functionalities for the computing resources. For example, the management model may be automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and numbers of management models may be implemented to provide additional functionalities using the computing resources without departing from the scope of the embodiments disclosed herein.

In one or more embodiments, in conjunction with the orchestrator, a system control processor (not shown) of a related IHS may cooperatively enable hardware resource sets of other IHSs to be prepared and presented as bare metal resources to composed IHSs. The system control processor may be operably connected to external resources (not shown) via a network interface and the network (130) so that the system control processor may prepare and present the external resources as bare metal resources as well.

In one or more embodiments, a compute resource set, a control resource set, and/or a hardware resource set may be implemented as separate physical devices. In such a scenario, any of these resource sets may include NICs or other devices to enable the hardware devices of the respective resource sets to communicate with each other.

While an IHS (e.g., 120A) has been illustrated and described as including a limited number of specific components and/or hardware resources, the IHS (e.g., 120A) may include additional, fewer, and/or different components without departing from the scope of the embodiments disclosed herein. One of ordinary skill will appreciate that an IHS (e.g., 120A) may perform other functionalities without departing from the scope of the embodiments disclosed herein.

In one or more embodiments, an IHS (e.g., 120A) may be implemented as a computing device (e.g., 500, FIG. 5). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored to the persistent storage, that when executed by the processor(s) of the computing device cause the computing device to perform the functionality of the IHS described throughout the application.

Alternatively, in one or more embodiments, similar to a client (e.g., 110A), the IHS (e.g., 120A) may also be implemented as a logical device.

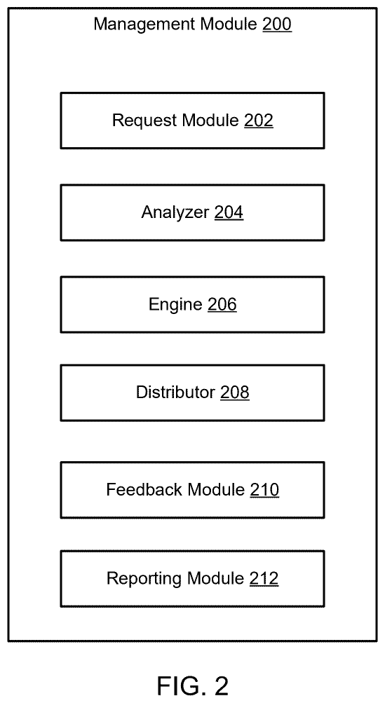

In one or more embodiments, the management module (125) may host a request module (e.g., 202, FIG. 2), an analyzer (e.g., 204, FIG. 2), an engine (e.g., 206, FIG. 2), a distributor (e.g., 208, FIG. 2), a feedback module (e.g., 210, FIG. 2), and a reporting module (e.g., 212, FIG. 2). Additional details of the request module, analyzer, engine, distributor, feedback module, and reporting module are described below in reference to FIG. 2.

In the embodiments of the present disclosure, the database (115) is demonstrated as a separate entity from an IHS (e.g., 120A); however, embodiments disclosed herein are not limited as such. The database (115) may be demonstrated as a part of the IHS (e.g., as deployed to the IHS).

In one or more embodiments, the database (115) may provide long-term, durable, high read/write throughput data storage/protection with near-infinite scale and low-cost. The database (115) may be a fully managed cloud/remote (or local) storage (e.g., pluggable storage, object storage, block storage, file system storage, data stream storage, Web servers, unstructured storage, etc.) that acts as a shared storage/memory resource that is functional to store unstructured and/or structured data. Further, the database (115) may also occupy a portion of a physical storage/memory device or, alternatively, may span across multiple physical storage/memory devices.

In one or more embodiments, the database (115) may be implemented using physical devices that provide data storage services (e.g., storing data and providing copies of previously stored data). The devices that provide data storage services may include hardware devices and/or logical devices. For example, the database (115) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database (115) may include a memory device (e.g., a dual in-line memory device), in which data is stored and from which copies of previously stored data are provided. As yet another example, the database (115) may include a persistent storage device (e.g., an SSD), in which data is stored and from which copies of previously stored data is provided. As yet another example, the database (115) may include (i) a memory device in which data is stored and from which copies of previously stored data are provided and (ii) a persistent storage device that stores a copy of the data stored to the memory device (e.g., to provide a copy of the data in the event that power loss or other issues with the memory device that may impact its ability to maintain the copy of the data).

Further, the database (115) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the database (115) may store/record unstructured and/or structured data that may include (or specify), for example (but not limited to): an identifier of a user/customer (e.g., a unique string or combination of bits associated with a particular user); a request received from a user (or a user's account); a geographic location (e.g., a country) associated with the user; a timestamp showing when a specific request is processed by an application; a port number (e.g., associated with a hardware component of a client (e.g., 110A)); a protocol type associated with a port number; computing resource details (including details of hardware components and/or software components) and an IP address of an IHS (e.g., 120N) hosting an application where a specific request is processed; an identifier of an application; information with respect to historical metadata (e.g., system logs, applications logs, telemetry data including past and present device usage of one or more computing devices in the system (100), etc.); computing resource details and an IP address of a client that sent a specific request (e.g., to an IHS (e.g., 120A)); one or more points-in-time and/or one or more periods of time associated with a data recovery event; data for execution of applications/services (including IHS applications and associated end-points); corpuses of annotated data used to build/generate and train processing classifiers for trained ML models; linear, non-linear, and/or ML model parameters; an identifier of a sensor; a product identifier of a client (e.g., 110A); a type of a client; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; an identifier of a data item; a size of the data item; a distributed model identifier that uniquely identifies a distributed model; a user activity performed on a data item; a cumulative history of user/administrator activity records obtained over a prolonged period of time; a setting (and a version) of a mission critical application executing on an IHS (e.g., 120A); an SLA/SLO set by a user; a data protection policy (e.g., an affinity-based backup policy) implemented by a user (e.g., to protect a local data center, to perform a rapid recovery, etc.); a configuration setting of that policy; product configuration information associated with a client; a number of each type of a set of assets protected by an IHS (e.g., 120N); a size of each of the set of assets protected; a number of each type of a set of data protection policies implemented by a user; configuration information associated with an IHS (e.g., 120A) (to manage security, network traffic, network access, or any other function/operation performed by the IHS); a job detail of a job (e.g., a data protection job, a data restoration job, a log retention job, etc.) that has been initiated by an IHS (e.g., 120A); a type of the job (e.g., a non-parallel processing job, a parallel processing job, an analytics job, etc.); information associated with a hardware resource set of an IHS (e.g., 120A); a completion timestamp encoding a date and/or time reflective of a successful completion of a job; a time duration reflecting the length of time expended for executing and completing a job; a backup retention period associated with a data item; a status of a job (e.g., how many jobs are still active, how many jobs are completed, etc.); information regarding an administrator (e.g., a high-priority trusted administrator, a low-priority trusted administrator, etc.) related to an analytics job; a workflow (e.g., a policy that dictates how a workload should be configured and/or protected, such as an SQL workflow dictates how an SQL workload should be protected) set (by a user); a type of a workload that is tested/validated by an administrator per data protection policy; a practice recommended by a manufacturer (e.g., a single data protection policy should not protect more than 100 assets; for a dynamic NAS, maximum one billion files can be protected per day, etc.); one or more device state paths corresponding to a client; an existing knowledge base (KB) article; a technical support history documentation of a customer/user; a port's user guide; a port's release note; a community forum question and its associated answer; a catalog file of an application upgrade; details of a compatible OS version for an application upgrade to be installed; an application upgrade sequence; a solution or a workaround document for a software failure; one or more lists that specify which computer-implemented services should be provided to which user (depending on a user access level of a user); a fraud report for an invalid user; a set of SLAs (e.g., an agreement that indicates a period of time required to retain a profile of a user); information with respect to a user/customer experience; user-specific workload requirements; etc.

In one or more embodiments, metadata (e.g., system logs, application logs, etc.) may be obtained (or dynamically fetched) as they become available (e.g., with no user manual intervention), or by an analyzer (not shown) of an IHS (e.g., 120A) polling a corresponding client (e.g., 110A) (by making schedule-driven/periodic application programming interface (API) calls to the client without affecting the client's ongoing production workloads) for newer metadata. Based on receiving the API calls from the analyzer, the client may allow the analyzer to obtain the metadata.

In one or more embodiments, the metadata may be obtained (or streamed) continuously as they generated, or they may be obtained in batches, for example, in scenarios where (i) the analyzer receives a metadata analysis request (or a health check request for a client), (ii) another IHS of the system (100) accumulates the metadata and provides them to the analyzer at fixed time intervals, or (iii) the database stores the metadata and notify the analyzer to access the metadata from the database (115). In one or more embodiments, metadata may be access-protected for transmission from a corresponding client (e.g., 110A) to the analyzer, e.g., using encryption.

While the unstructured and/or structured data are illustrated as separate data structures and have been discussed as including a limited amount of specific information, any of the aforementioned data structures may be divided into any number of data structures, combined with any number of other data structures, and/or may include additional, less, and/or different information without departing from the scope of the embodiments disclosed herein.

Additionally, while illustrated as being stored to the database, any of the aforementioned data structures may be stored to different locations (e.g., in persistent storage of other computing devices) and/or spanned across any number of computing devices without departing from the scope of the embodiments disclosed herein.

In one or more embodiments, the unstructured and/or structured data may be updated (automatically) by third-party systems (e.g., platforms, marketplaces, etc.) and/or by the administrators based on, for example, newer (e.g., updated) versions of SLAs. The unstructured and/or structured data may also be updated when, for example (but not limited to): newer system logs are received, a state of an IHS (e.g., 120A) is changed, etc.

While the database has been illustrated and described as including a limited number and type of data, the database may store additional, less, and/or different data without departing from the scope of the embodiments disclosed herein. One of ordinary skill will appreciate that the database may perform other functionalities without departing from the scope of the embodiments disclosed herein.

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., clients, IHSs, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the IHSs through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VOIP), etc.

While FIG. 1 shows a configuration of components, other system configurations may be used without departing from the scope of the embodiments disclosed herein.

Turning now to FIG. 2, FIG. 2 shows a diagram of a management module (200) in accordance with one or more embodiments disclosed herein. The management module (200) may be an example of the management module discussed above in reference to FIG. 1. The management module (200) includes the request module (202), the analyzer (204), the engine (206), the distributor (208), the feedback module (210), and the reporting module (212). The management module (200) may include additional, fewer, and/or different components without departing from the scope of the embodiments disclosed herein. Each component may be operably connected to any of the other component via any combination of wired and/or wireless connections. Each component illustrated in FIG. 2 is discussed below.

In one or more embodiments, the request module (202) may include functionality to, e.g.,: (i) act as an entry point for users/administrators to submit their computational workload specifications (e.g., user-specific workload requirements); (ii) capture/obtain user-specific workload requirements (e.g., requirements of an ML inferencing workload, requirements of a Kubernetes workload, etc.), for example, from a user and/or the database (e.g., 115, FIG. 1); (iii) by employing linear, non-linear, and/or ML models, process obtained workload specifications to generate clearly defined and delineated workload specifications; and/or (iv) forward/send the clearly defined and delineated workload specifications to the analyzer (204).

In one or more embodiments, a user-specific workload requirement may specify (or include), for example (but not limited to): amount of computing resource (e.g., CPU, GPU, DPU, storage space, memory, etc.) required to execute a workload, a geographic location preference to execute a workload, a compliance related parameter that needs to be considered to execute a workload, a cooling requirement to execute a workload, a humidity requirement to execute a workload (e.g., when the humidity level within IHS R is above 55%, no additional workload should be assigned to IHS R and some of the current workloads (being executed on IHS R) should be assigned to other IHSs), an airflow management requirement to execute a workload, etc.

In one or more embodiments, a geographic location preference may include (or specify), for example (but not limited to): a temperature rating of a location (because, for example, when IHSs are deployed to locations with harsh environment conditions (e.g., −40° C.-60° C.), the IHSs may not operate properly, and, in certain scenarios, may be damaged), a hurricane rating of a location, a required number of uninterruptible power supplies (UPSs) to support execution of a workload, etc.

In one or more embodiments, a compliance related parameter may include (or specify), for example (but not limited to): a General Data Protection Regulation (GDPR) compliance requirement (e.g., different “types” personal data may require different levels of protection, for example, sensitive data (e.g., health data, biometrics data, genetic data, criminal history data, etc.) may be subject to the highest levels of data protection; organizations may get consent (from users or data subjects) to collect personal data (with the level of consent varying according to the type of personal data being collected); an organization that collects personal data for a targeted purpose may not use the collected data for another purpose (such as consumer profiling, which may be considered “non-compliant”); data subjects (i.e., the data subjects whose personal data is being collected) may be able to understand why their data is being collected and how it is being processed, and they may have the right to object, correct, and/or remove the data; etc.); a Sarbanes-Oxley Act (SOX) compliance requirement (e.g., prevent data tampering and monitor for breaches, document activity timelines and encrypt the data, install access tracking controls that may identify breaches, check constantly to ensure defense systems are working, analyze security system data (and improve when needed), implement real-time security breach tracking, grant auditors defense system access for complete transparency, disclose security incidents to auditors for a quick response, report technical difficulties to auditors and avoid stalls, etc.); a Health Insurance Portability and Accountability (HIPAA) compliance requirement (e.g., ensure the confidentiality, integrity, and availability of all protected health information (PHI) in any form (e.g., electronic, paper, oral, etc.); identify and protect against reasonably anticipated security threats; protect against reasonably anticipated, impermissible uses or disclosures; ensure compliance of workforce and business associates; etc.); a Payment Card Industry Data Security Standard (PCI DSS) compliance requirement (unlike HIPAA and GDPR requirements, which are based on governmental regulation(s), PCI DSS compliance requirements are contractual commitments maintained and enforced by the Payment Card Industry Security Standards Council) (e.g., build and maintain a secure network and system; protect cardholder data; maintain a vulnerability management program (e.g., quarterly vulnerability scans, annuals assessments, etc.); implement strong access control measures; regularly monitor and test networks; maintain an information security policy; etc.); a California Consumer Privacy Act (CCPA) compliance requirement (e.g., users may have the right to know what personal data is collected or sold (and for what purpose); users may have access to personal data, to request its deletion, and/or to opt-out being collected or sold; users may have the right to sue companies for data breaches and for privacy failures; etc.); a Personal Information Protection and Electronic Documents Act (PIPEDA) compliance requirement (e.g., an organization may need to obtain its users' consent prior to data collection; an organization may need to uphold transparent personal data policies, and limit data collection to clear and specific purposes; users may need to have the right to access their data and to challenge its accuracy; organizations may be held accountable for data loss or theft; organizations may need to disclose security breaches of personal data to individuals who affected by the breach; etc.); etc.

In one or more embodiments, a cooling requirement may specify (or include), for example (but not limited to): a cooling technology/component (e.g., a fan, a refrigerant-based cooling technology (e.g., a direct expansion (DX) coil), a liquid cooling component, a fluid mixture based cooling technology, an “in-row” cooling component, a “room-based” cooling component, etc.) that needs to be employed in order to execute a workload, cooling resiliency (e.g., having a redundant fan) that needs to be satisfied before executing a workload, a temperature threshold associated with a specific IHS that needs to be considered while executing a workload (e.g., when the temperature level within IHS R is above 35° C., no additional workload should be assigned to IHS R and some of the current workloads (being executed on IHS R) should be assigned to other IHSs), a heat dissipation threshold associated with a specific IHS while executing a workload, a thermal management infrastructure that needs to be satisfied in order to execute a workload, etc.

One of ordinary skill will appreciate that the request module (202) may perform other functionalities without departing from the scope of the embodiments disclosed herein. The request module (202) may be implemented using hardware (e.g., a physical device including circuitry), software, or any combination thereof.

In one or more embodiments, the analyzer (204) may include functionality to, e.g.,: (i) be tasked with the aggregation and initial processing of data related to IHS operations (e.g., historical and real-time data on IHS workloads, thermal outputs, energy consumption, environmental conditions, etc.); (ii) obtain/receive clearly defined and delineated workload specifications from the request module (202); (iii) through continuous monitoring, obtain real-time “health” data (or telemetry data) (e.g., computing resource utilization data (or key performance metrics such as processor usage, memory load, network traffic, etc.) associated with of hardware components and/or software components of an IHS, an IHS' internal temperature level, an IHS' internal humidity level, an IHS' thermal output, an IHS' energy consumption, an IHS' environmental conditions, heating and/or cooling system performance of an IHS, etc.) from all IHSs in the system (e.g., 100, FIG. 1); (iv) by employing linear, non-linear, and/or ML models, perform necessary preprocessing tasks (e.g., data cleaning, data normalization, data transformation, etc.) on the real-time data to obtain preprocessed data (e.g., structured data) (so that the real-time data will be prepared for analyses in terms of, at least, uncovering underlying patterns and correlations to generate robust predictive models); (v) based on the preprocessed data and for each hardware component and/or software component (of a related IHS), derive a continuous average resource utilization value with respect to each computing resource; (vi) based on the preprocessed data and for each hardware component and/or software component (of the related IHS), derive minimum and maximum resource utilization values with respect to each computing resource; (vii) identify a health state/status of each component (and, indirectly, an health state of the related IHS) based on average, minimum, and maximum resource utilization values; (viii) based on (vii), automatically react and generate alerts whether one of the predetermined maximum resource utilization value thresholds is exceeded; (ix) provide/send an identified health state (e.g., healthy, unhealthy, etc.) of the related IHS and generated alerts (if any) to other entities (e.g., 206) in order to manage the health state of the related IHS; (x) provide the preprocessed data to the engine (206) and/or the distributor (208) for further analyses (e.g., predictive analyses to infer an IHS' future health state); and/or (x) store the preprocessed data, generated alerts (if any), and identified health state of each IHS to the database (e.g., 115, FIG. 1), for example, to generate a resource utilization map.

As used herein, “unhealthy” may refer to a compromised health state (e.g., an unhealthy state), indicating a corresponding entity (e.g., a hardware component, an IHS, etc.) has already or is likely to, in the future, be no longer able to provide the services that the entity has previously provided. The health state determination may be made via any method based on the aggregated health information without departing from the scope of the embodiments disclosed herein.

In one or more embodiments, while monitoring, the analyzer (204) may need to, for example (but not limited to): inventory one or more hardware components and/or software components of an IHS (e.g., 120A, FIG. 1); obtain type and model information of each component of an IHS; obtain a version of firmware or other code executing on a component of an IHS; obtain information specifying each component's interaction with one another in an IHS and/or with another component of a second IHS; etc.

In one or more embodiments, the analyzer (204) may derive minimum and maximum resource utilization values (with respect to each computing resource) as a reference to infer whether a continuous average resource utilization value (with respect to each computing resource) is derived properly. If there is an issue with the derived continuous average resource utilization value, based on the reference, the analyzer (204) may re-derive the continuous average resource utilization value.

In one or more embodiments, a resource utilization map may be implemented using one or more data structures that include information regarding the utilization of computing resources of an IHS. A resource utilization map may specify, for example (but not limited to): an identifier of a microservice executing on an IHS, an identifier of a computing resource, an identifier of a computing resource that has been utilized by a microservice, etc.

The resource utilization map may specify the resource utilization by any means. For example, the resource utilization map may specify an amount of utilization, resource utilization rates over time, power consumption of applications/microservices while utilized by a user, workloads performed using microservices, etc. The resource utilization map may include other types of information used to quantify the utilization of resources by microservices without departing from the scope of the embodiments disclosed herein.

In one or more embodiments, the resource utilization map may be maintained by, for example, the analyzer (204). The analyzer (204) may add, remove, and/or modify information included in the resource utilization map to cause the information included in the resource utilization map to reflect the current utilization of the computing resources. Data structures of the resource utilization map may be implemented using, for example, lists, tables, unstructured data, structured data, etc. While described as being stored locally, the resource utilization map may be stored remotely and may be distributed across any number of devices without departing from the scope of the embodiments disclosed herein.

One of ordinary skill will appreciate that the analyzer (204) may perform other functionalities without departing from the scope of the embodiments disclosed herein. The analyzer (204) may be implemented using hardware, software, or any combination thereof.

In one or more embodiments, the engine (206) may include functionality to, e.g.,: (i) receive/obtain (a) the preprocessed data (including, at least, historical and current workload activities performed on each IHS, thermal output, cooling requirements, and environmental conditions of each IHS) and (b) identified health state of each IHS and generated alerts (if any); (ii) based on (i) and by employing linear, non-linear, and/or ML models, perform predictive analyses to make predictions (or predictive forecasts) about (a) future workload demands associated with each IHS (e.g., next Wednesday, IHS G's workload demand will be high because of a planned sales event) and (b) a future health state of each IHS (including, at least, future thermal output and cooling requirements of each IHS) (e.g., because of the planned sales event, IHS G's internal temperature level will be increased 25% and more IHS G will be requiring more cooling to keep its overall health state stable); (iii) based on (i) and by performing feature engineering, derive variables/features that significantly impact thermal output of an IHS (e.g., aggregating workload metrics into (a) a “thermal load” feature which represents the expected heat output based on the type and intensity of the computational tasks being executed on the IHS; (b) temporal or cyclic patterns of a workload and interactions between different types of workloads in the IHS; etc.), in which with the engineered features (and by employing ML models), the engine (206) may predict the current and historical workload information of the IHS; (iv) based on (ii), generate predictive insights about each IHS' (e.g., because IHS G's internal temperature level will be increased 25%, next Wednesday, IHS G should not be performing compute-intensive backup operations); (v) to perform real-time thermal modeling, combine the predictions from the models with real-time monitoring data (e.g., the preprocessed data) to generate a dynamic model of thermal characteristics across a data center (which involves simulating heat distribution and dissipation within one or more IHSs hosted by the data center), in which the dynamic and adaptive “thermal” model is updated in real-time to reflect changes in workload distribution, environmental conditions, and IHS cooling performance across the data center; (vi) generate/develop models (e.g., ML models) to predict an IHS' future workload state, thermal conditions, and cooling requirements; and/or (vii) send, at least, a future health state of each IHS and predictive insights about each IHS to the distributor (208).

In one or more embodiments, the dynamic and adaptive “thermal” model (which is generated through the integration of ML models with computational fluid dynamics (CFD) analyses) represents a novel approach to manage data center thermal conditions. This allows for highly accurate, predictive thermal management (of a data center) that may pre-emptively adjust cooling resources and workload distribution (across the data center) to optimize thermal efficiency. The dynamic and adaptive “thermal” model ensures that the engine's (206) predictive capabilities improve over time, adapting to newer operational patterns, environmental changes, and advancements occurring in the data center.

In one or more embodiments, the linear, non-linear, and/or ML models employed by the engine (206) may include, for example (but not limited to): time series forecasting models (e.g., autoregressive integrated moving average (ARIMA) and/or seasonal autoregressive integrated moving average (SARIMA) models that are employed for predicting future workload and thermal conditions of an IHS based on historical trends; seasonal decomposition models that are employed for analyzing seasonal patterns in an IHS' activity to perform more accurate forecasting), regression analysis models (e.g., linear and non-linear regression models that are employed for estimating the relationship(s) between various factors such as IHS workload, cooling efficiency, and thermal output), neural network models (e.g., the long short-term memory (LSTM) network model to capture long-term dependencies in time-series data (particularly effective in predicting thermal characteristics over time), which are useful to predict future IHS workload and thermal conditions; the gated recurrent units (GRUs) model; convolutional neural network (CNN) models; recurrent neural networks (RNN) models for capturing spatial and temporal dependencies; etc.), etc.

For example, the engine (206) may employ an ARIMA model (which is trained on historical IHS workload data) to capture seasonal trends (e.g., increased workload during business hours). By forecasting future workload amount/volume of a related IHS, the engine (206) may assist the distributor (208) to proactively redistribute some of the workloads of the IHS to underutilized IHSs before peak times (so that potential overload and thermal spike of the IHS can be prevented).

As yet another example, by employing an LSTM network model, the engine (206) may predict a significant increase in thermal output of a related IHS in response to a scheduled batch processing job. The engine (206) may then assist the distributor (208) to pre-emptively adjust cooling resources of the IHS or redistribute some of the workloads of the IHS to other available IHSs to maintain internal temperature of the IHS.

In one or more embodiments, the engine (206) may incorporate an adaptive learning mechanism that updates (e.g., retrains using any form of training data) one of the aforementioned ML models if the “trained (and/or fine-tuned)” model is not operating properly (e.g., if there are discrepancies between predicted and actual thermal characteristics of an IHS). The engine (206) may also periodically update each ML model as there are improvements in the related model (e.g., the model may be trained using more appropriate training data and may be tested using more appropriate testing data). This feedback loop allows the models to continuously improve their accuracy over time by learning from newer data and adapting to changes in data center operations and environmental conditions.

One of ordinary skill will appreciate that the engine (206) may perform other functionalities without departing from the scope of the embodiments disclosed herein. The engine (206) may be implemented using hardware, software, or any combination thereof.

In one or more embodiments, as being a global thermal-aware workload distribution component, the distributor (208) may include functionality to, e.g.,: (i) receive/obtain, at least, a future health state of each IHS and predictive insights about each IHS from the engine (206); (ii) by employing linear, non-linear, and/or ML models (e.g., multi-criteria decision analysis models, genetic models, simulated annealing models, Pareto optimization models, etc.), analyze the data received in (i) (e.g., translate predictions into actionable strategies for workload distributions across IHSs in data centers and cooling management of those IHSs), the preprocessed data (including a current health state, computing resource capabilities, thermal output, an energy consumption rate, and environmental conditions of each IHS) received from the analyzer (204), and the global data center landscape (of the system (e.g., 100, FIG. 1)) to take informed actions (e.g., balancing thermal management (or thermal efficiency) of a data center with its computational demands (while considering data center performance targets (in terms of latency, throughput, and system resilience) and policies for a better user experience), proactively managing workloads and cooling strategies in a data center (e.g., managing hot aisle and/or cold aisle configurations in the data center, initiating the deployment of hot aisle and/or cold aisle containment systems in the data center, etc.), enhancing energy efficiency of the data center by pre-emptively adapting to predicted thermal demands (e.g., cooling requirements, heating requirements, humidity removal requirements, air flow requirements, etc.) of the data center based on the anticipated workload and environmental conditions); (iii) based on (ii), generate an IHS list, in which the list specifies, at least, candidate IHSs and relevant metrics (e.g., computing resource metrics, cooling and/or heating resource metrics, hardware resource set limits, cooling system capabilities, etc.) of those IHSs for hosting one or more workloads (e.g., user-defined workloads); (iv) based on the IHS list and by employing linear, non-linear, and/or ML models, identify the best-suited IHS(s) for workload allocation (while considering different geographical locations based on factors such as energy efficiency, thermal efficiency, regional weather conditions, legal constraints (or compliance related parameters), and geographical preferences of a user); (v) when necessary and based on the IHS list, adjust allocation/placement and execution of workloads across multiple data center locations and regulate heating and/or cooling system in real-time (e.g., considering current and future/forecasted state of each IHS in a data center, dynamically migrate a workload from an unhealthy IHS to another healthy IHS within the data center to ensure that workloads are optimally balanced and cooling resources are efficiently used, leading to enhanced operational efficiency, thermal efficiency, and reduced energy consumption in the data center; dynamically shift a workload to an IHS that is deployed to an energy-efficient data center (which is located in a cooler environment/climate; etc.); (vi) based on (v) and by employing complex event processing models, perform real-time monitoring of global data center conditions (e.g., temperature, energy usage, computing resource utilization, operational capacities, environment conditions, etc., of each IHS in data centers); (vii) based on (vi), generate workload performance data (which specifies, at least, an operational state of each workload being executed on all IHSs across a global network of data centers); (viii) based on the workload performance data (e.g., by analyzing the workload performance data against predetermined thresholds and/or user-defined rules (related to energy efficiency, thermal management, operational costs, compliance with data sovereignty laws and regulations, etc.)), if necessary (e.g., if an IHS is experiencing unexpected thermal anomalies, if an IHS is experiencing unexpected workload fluctuations, etc.), initiate urgent redistribution of workloads across suitable IHSs (within the global network of data centers) and trigger alerts to redefine cooling and/or heating strategies of related IHSs before any thresholds and/or rules are breached; (ix) based on (viii), generate updated workload performance data (which specifies, at least, an updated operational state of each workload after workload redistributions and redefined cooling and/or heating strategies are performed); and/or (x) provide the updated workload performance data to the feedback module (210).

In one or more embodiments, an operational state of a workload may specify, for example (but not limited to): 70% of Workload A is completed on IHS F, a type of a workload being executed on an IHS, Workload B is in an idle state on IHS D, current computing resource utilization of a workload on an IHS, a system log associated with a workload, an application log associated with a workload, etc.

In one or more embodiments, the distributor (208) may also provide the following benefits for data center management: (i) enhanced thermal efficiency (by intelligently redistributing workloads to cooler or more energy-efficient data center locations, the distributor (208) may significantly reduce the need for artificial cooling and lower energy consumption and operational costs), (ii) operational resilience (by spreading workloads across multiple data centers, the distributor (208) may mitigate the risk of overload and failure in any single data center location, enhancing overall system reliability), (iii) cost reduction (by leveraging geographical differences in energy prices and climate conditions the distributor (208) may enable substantial cost savings, particularly in locations/regions with cooler climates and lower energy costs), (iv) environmental sustainability (the distributor (208) may enable reduced reliance on cooling systems and optimized energy usage to lower carbon emissions, aligning data center operations with sustainability goals), (v) holistic optimization (the distributor (208) may perform decisions by considering a comprehensive range of operational and strategic objectives, for more balanced and effective management of data center resources), (vi) adaptive decision-making (the distributor (208) may enable dynamic adjustment of strategies in response to changing conditions, predictive insights, and evolving operational goals of data centers), and (vii) increased resilience (the distributor (208) may support the development of strategies that enhance the resilience of data center operations towards mitigating risks associated with system failures, thermal anomalies, and fluctuating workloads).

One of ordinary skill will appreciate that the distributor (208) may perform other functionalities without departing from the scope of the embodiments disclosed herein. The distributor (208) may be implemented using hardware, software, or any combination thereof.

In one or more embodiments, the feedback module (210) may include functionality to, e.g.,: (i) obtain/receive the updated workload performance data to the distributor (208); (ii) obtain predictive insights about each IHS from the engine (206); (iii) by implementing a reinforcement learning strategy, analyze the data obtained in (i)-(ii) against actual outcomes to analyze/evaluate the distributor's and the engine's performance; (iv) based on (iii), if necessary, update/refine (e.g., by employing a Q-learning model) models and strategies used by the distributor and the engine to enhance overall efficiency of the global network of data centers; and/or (v) deploy the updated models to the distributor and the engine as part of a continuous learning cycle.

One of ordinary skill will appreciate that the feedback module (210) may perform other functionalities without departing from the scope of the embodiments disclosed herein. The feedback module (210) may be implemented using hardware, software, or any combination thereof.

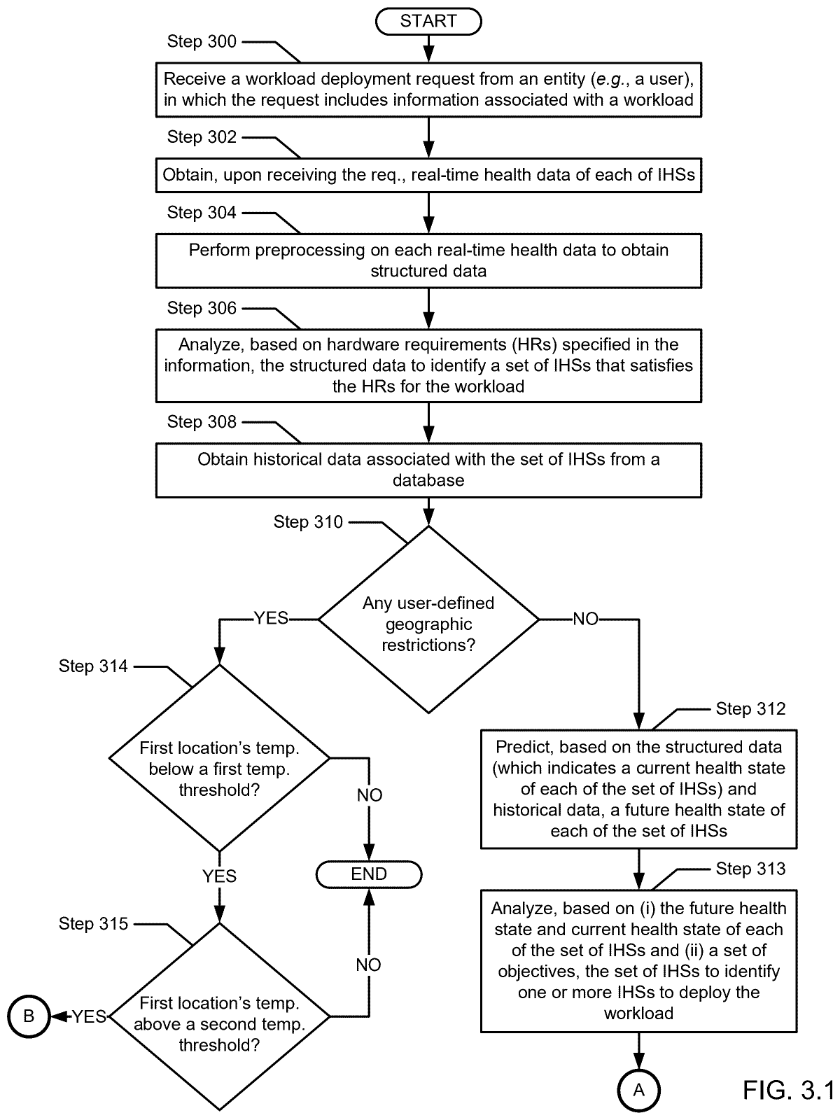

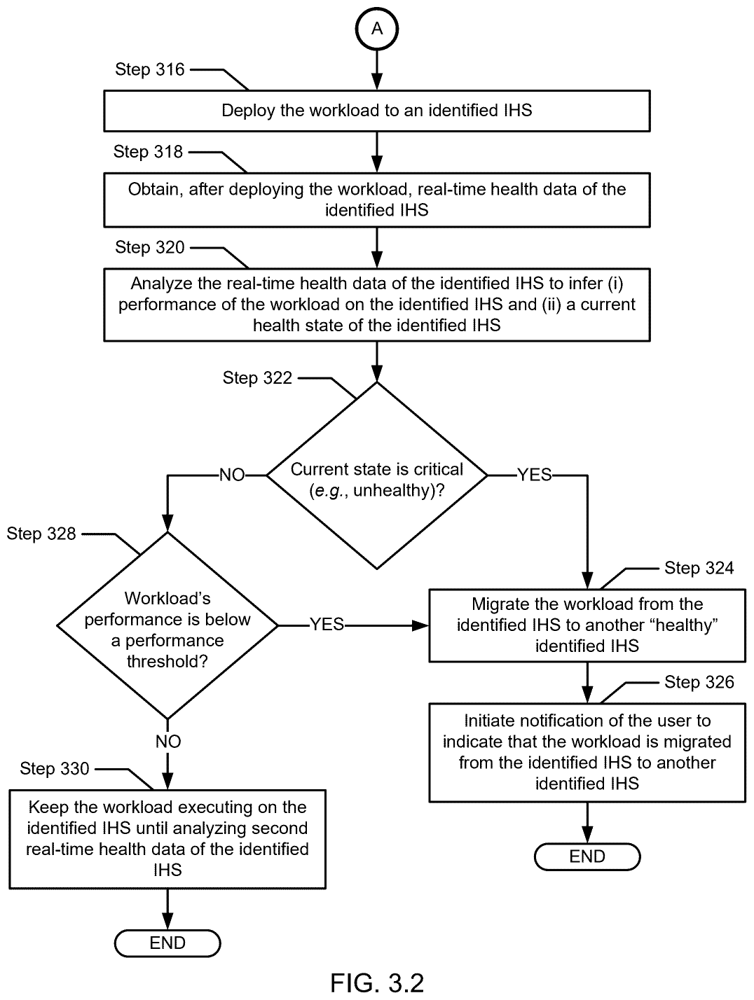

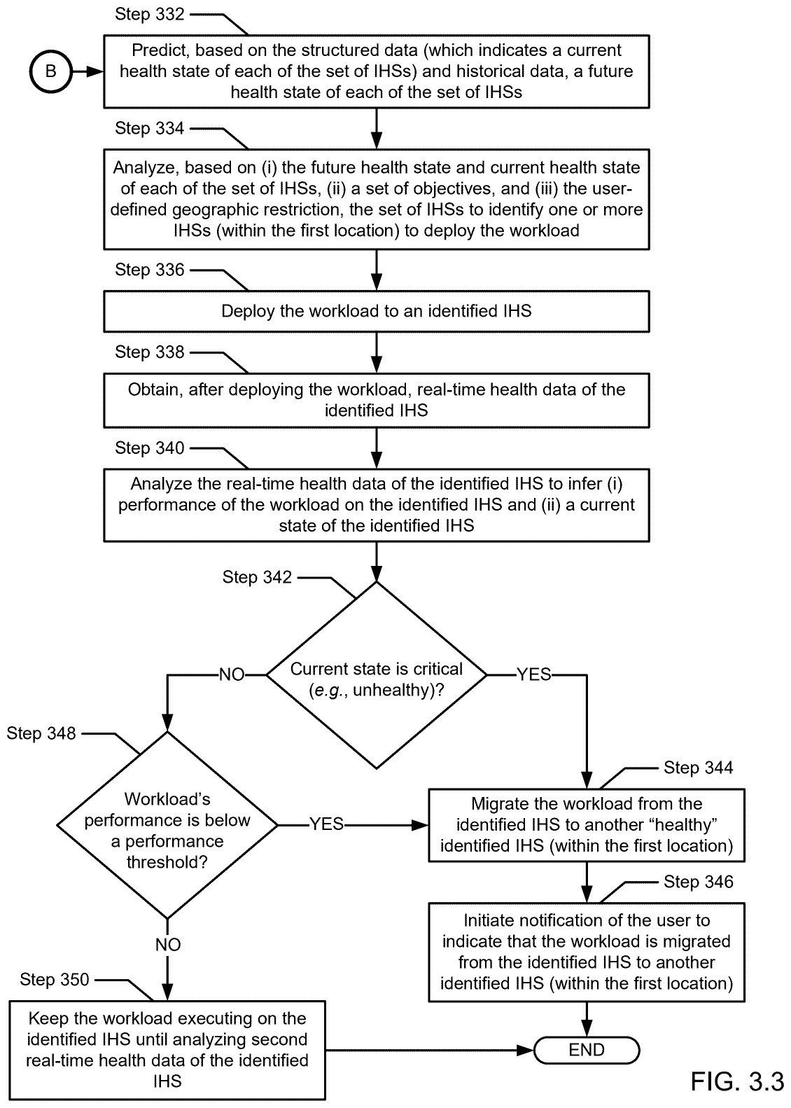

In one or more embodiments, the reporting module (212) may include functionality to, e.g.,: (i) obtain/receive aggregated data (e.g., the updated workload performance data (specifying performance metrics of each IHS), predictive insights about each IHS, information with respect to updated models, preprocessed data, the IHS list, etc.) from each component of the management module (200); (ii) by employing linear, non-linear, and/or ML models, analyze the aggregated data to generate a report that provides in-depth insights into each IHS' efficiency and effectiveness; (iii) provide the report to administrators so that the administrators/stakeholders may have comprehensive insights into overall data center operations and performance towards making more informed decisions and strategic planning; (iv) encompass hardware components and/or software components and functionalities provided by the management module (200) to operate as a service over the network (e.g., 130, FIG. 1) so that the reporting module (212) may be used externally; (v) employ a set of subroutine definitions, protocols, hardware components, and/or software components for enabling/facilitating communications between, for example, the reporting module (212) and external entities (e.g., administrators, etc.); (vi) by generating one or more visual elements, allow an administrator to, at least, interact with a related IHS; (vii) concurrently display one or more separate windows, for example, on its GUI (or a a programmatic interface) to indicate an overall health state of an IHS; and/or (viii) generate visualizations of the method illustrated in FIGS. 3.1-3.3.

In one or more embodiments, for example, (i) each data item of the aggregated data may be displayed (e.g., highlighted, visually indicated, etc.) with a different color (e.g., red color tones may represent a negative overall health state of an IHS, green color tones may represent a positive overall health state of an IHS, etc.), and (ii) one or more useful insights/recommendations with respect to an overall health state of a data center may be displayed in a separate window(s) on the reporting module (212) to assist an administrator while managing, for example, the overall health state of the data center (e.g., for a better administrator experience, to help the administrator with respect to understanding the benefits and trade-offs of selecting different troubleshooting options, etc.).

One of ordinary skill will appreciate that the reporting module (212) may perform other functionalities without departing from the scope of the embodiments disclosed herein. The reporting module (212) may be implemented using hardware, software, or any combination thereof.

In one or more embodiments, the request module (202), the analyzer (204), the engine (206), the distributor (208), the feedback module (210), and the reporting module (212) may be utilized in isolation and/or in combination to provide the aforementioned functionalities towards optimizing data center operations. These functionalities may be invoked using any communication model including, for example, message passing, state sharing, memory sharing, etc.

FIGS. 3.1-3.3 show a method for managing workload distribution (across a global network of data centers including multiple IHSs) in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

The method discussed below may provide the following benefits in terms of the efficiency and effectiveness of data center operations: (i) proactive management of data center workloads and thermal conditions, (ii) beyond simply analyzing current IHS performance, consideration of long-term environmental forecasts (including climate change models, energy availability forecasts, and geopolitical shifts) (which provides a forward-looking approach that anticipates and adapts to future challenges, optimizing workload distribution not just for immediate operational efficiency but also for long-term data center sustainability and resilience), (iii) dynamic reallocation of workloads across the global network (while factoring in real-time changes in energy costs, climate conditions, and geopolitical landscapes), (iv) environmentally friendly operations (with predictive cooling and workload management, the overall energy consumption of the global network is reduced, leading to a smaller carbon footprint and alignment with sustainability goals), (v) enhanced IHS performance (by maintaining optimal thermal conditions, the method ensures that IHSs operate within their most efficient temperature range (this not only prolongs hardware component lifespan but also maintains high performance, as IHSs tend to slow down when overheated)), (vi) reduced cooling costs (predictive analytics enable the method to optimize the use of cooling resources (by accurately forecasting when and where cooling is most needed, the method can reduce unnecessary cooling during low-risk periods, leading to substantial energy savings)), and (vii) minimized downtime (by predicting workload amount and thermal conditions of an IHS, the method can prevent overheating and subsequent IHS failures (this proactive management significantly reduces the likelihood of unplanned downtime, ensuring continuous and reliable data center operations)).

Turning now to FIG. 3.1, the method shown in FIG. 3.1 may be executed by, for example, the above-discussed components of the management module (e.g., 200, FIG. 2). Other components of the system (100) illustrated in FIG. 1 may also execute all or part of the method shown in FIG. 3.1 without departing from the scope of the embodiments disclosed herein.

In Step 300, the request module (e.g., 202, FIG. 2) receives a workload deployment request from a requesting entity (e.g., from a user, from a user terminal, etc.), in which the request includes, at least, information associated with a workload (that needs to be deployed). In one or more embodiments, the request module may send/forward the workload deployment request to the analyzer (e.g., 204, FIG. 2).

In Step 302, in response to receiving the request, as part of that request, and/or in any other manner (e.g., before initiating any computation with respect to the request), the analyzer obtains real-time health data of each IHS (or a set of IHSs) within the global network of data centers.

In one or more embodiments, real-time health data of a related IHS (e.g., 110A, FIG. 1) may be obtained (or dynamically fetched) as they become available (e.g., with no user manual intervention), or by the analyzer polling the related IHS (by making schedule-driven/periodic API calls to the related IHS without affecting the IHS' ongoing production workloads) for newer data. Based on receiving the API calls from the analyzer, the related IHS may allow the analyzer to obtain the data. In one or more embodiments, the data may be access-protected for transmission from the related IHS to the analyzer, e.g., using encryption.

In Step 304, by employing linear, non-linear, and/or ML models, the analyzer performs preprocessing on each real-time health data to obtain preprocessed/structured data. In one or more embodiments, real-time health data may specify, for example (but not limited to): a hardware resource set of an IHS, a number of workloads being executed by an IHS, a current exhaust temperature of an IHS, current energy consumption of an IHS, a system log associated with an IHS, an application log associated with an IHS, an air intake amount of an IHS, location information of an IHS, etc.

In Step 306, based on the hardware requirements (specified in the information that is received via the request in Step 302) and by employing linear, non-linear, and/or ML models, the analyzer analyzes the structured data to identify a second set of IHSs that satisfies the hardware requirements for the workload.

In one or more embodiments, the information may further specify, for example (but not limited to): a hardware resource set including a hardware requirement that needs to be satisfied by a candidate IHS (that is identified to host the workload), an operational requirement that needs to be satisfied by a candidate IHS, a data compliance regulation (including one or more compliance related parameters) that needs to be considered while identifying a candidate IHS, etc.

In Step 308, the analyzer obtains historical data associated with the second set of IHSs from the database (e.g., 115, FIG. 1). Thereafter, the analyzer may send the historical data, structured data, and request (received in Step 300) to the engine (e.g., 206, FIG. 2).

In Step 310, based on the information (received via the request in Step 308), the engine makes a first determination (in real-time or near real-time) as to whether any user-defined geographic restrictions (e.g., in terms of climate conditions, local energy costs, legal and regulatory constraints affecting data storage and processing (e.g., GDPR related constraints), etc.) need to be considered (before deploying the workload to an IHS). Accordingly, in one or more embodiments, if the result of the first determination is NO, the method proceeds to Step 312. If the result of the first determination is YES, the method alternatively proceeds to Step 314.

In Step 312, as a result of the first determination in Step 310 being NO (which means that the information does not specify a user-defined geographic restriction that needs to be considered while deploying the workload), the engine, by employing linear, non-linear, and/or ML models (e.g., a trained multi-objective optimization model) and based on the structured data (which indicates, at least, a current health state of each of the second set of IHSs) and the historical data, the engine predicts a future health state of each of the second set of IHSs. Thereafter, the engine may send the structured data and the future health state of each of the second set of IHSs to the distributor (e.g., 208, FIG. 2).

In one or more embodiments, a future health state of an IHS may have the highest probability to become the future health state among a list of future health states associated with the IHS. Further, the future health state may specify at least a projected thermal condition of the IHS and a number of workloads that is projected to be executed by the IHS.

In Step 313, based on (i) a set of objectives (e.g., defined/provided by the user) and (ii) the future health state of each of the second set of IHSs and the structured data, the distributor analyzes the second set of IHSs to identify a third set of IHSs to deploy the workload. In one or more embodiments, the set of objectives may dictate, at least, deploying the workload to a high performance and energy-efficient IHS within the global network of datacenters, and thermally managing the global network of datacenters (which includes, at least, the aforementioned sets of IHSs).

In Step 314, as a result of the first determination in Step 310 being YES (which means that the information specifies a user-defined geographic restriction that needs to be considered while deploying the workload (e.g., the workload needs to be deployed to a first location)), the engine makes a second determination (in real-time or near real-time) as to whether the first location's temperature is below a first temperature threshold (e.g., 25° C.). Accordingly, in one or more embodiments, if the result of the second determination is NO, the method may end. If the result of the second determination is YES, the method alternatively proceeds to Step 315.

In Step 315, as a result of the second determination in Step 314 being YES, the engine makes a third determination (in real-time or near real-time) as to whether the first location's temperature is above a second temperature threshold (e.g., 5° C.). Accordingly, in one or more embodiments, if the result of the third determination is NO, the method may end. If the result of the third determination is YES, the method alternatively proceeds to Step 332 of FIG. 3.3.

Turning now to FIG. 3.2, the method shown in FIG. 3.2 may be executed by, for example, the above-discussed components of the management module. Other components of the system (100) illustrated in FIG. 1 may also execute all or part of the method shown in FIG. 3.2 without departing from the scope of the embodiments disclosed herein.

In Step 316, based on Step 313 of FIG. 3.1, the distributor deploys the workload to an identified IHS of the third set of IHSs. In Step 318, after deploying the workload, the distributor obtains second real-time data of the identified IHS. In Step 320, by employing linear, non-linear, and/or ML models, the distributor analyzes the second real-time data of the identified IHS to infer, at least, (i) performance of the workload on the identified IHS and (ii) a current health state of the identified IHS.

In Step 322, based on Step 320, the distributor makes a fourth determination (in real-time or near real-time) as to whether the current health state of the identified IHS is critical (e.g., whether the identified IHS is unhealthy). Accordingly, in one or more embodiments, if the result of the fourth determination is YES, the method proceeds to Step 324. If the result of the fourth determination is NO, the method alternatively proceeds to Step 328.

In Step 324, as a result of the fourth determination in Step 322 being YES, the distributor migrates the workload from the identified IHS to another “healthy” identified IHS (e.g., a second IHS) of the third set of IHSs. The distributor may migrate the workload to another “healthy” identified IHS to manage distribution of the workload across the third set of IHSs and to manage a temperature of an internal environment of the identified IHS.

In one or more embodiments, the identified IHS may located in a first zone and the second IHS may be located in a second zone, in which the first zone may be a first geographic region in the world and the second zone may be a second geographic region in the world.

In Step 326, in conjunction with the reporting module (e.g., 212, FIG. 2), the distributor initiates notification of the user, via a GUI of the client, to indicate that the workload is migrated from the identified IHS to another identified IHS. In one or more embodiments, the method may end following Step 326.

In Step 328, as a result of the fourth determination in Step 322 being NO, the distributor makes a fifth determination (in real-time or near real-time) as to whether the workload's performance is below a predefined performance threshold. Accordingly, in one or more embodiments, if the result of the fifth determination is YES, the method returns to Step 324. If the result of the fifth determination is NO, the method alternatively proceeds to Step 330.

In Step 330, as a result of the fifth determination in Step 338 being NO, the distributor keeps the workload executing on the identified IHS until analyzing newer real-time data of the identified IHS (obtained at a later point-in-time after obtaining the second real-time health data in Step 318). Thereafter, in conjunction with the reporting module, the distributor initiates notification of the user, via the GUI of the client, to indicate that the workload is deployed to the identified IHS. In one or more embodiments, the method may end following Step 330.

Turning now to FIG. 3.3, the method shown in FIG. 3.3 may be executed by, for example, the above-discussed components of the management module. Other components of the system (100) illustrated in FIG. 1 may also execute all or part of the method shown in FIG. 3.3 without departing from the scope of the embodiments disclosed herein.

In Step 332, as a result of the second determination in Step 315 being YES, by employing linear, non-linear, and/or ML models, and based on the structured data (which indicates, at least, a current health state of each of the second set of IHSs) and the historical data, the engine predicts a future health state of each of the second set of IHSs. Thereafter, the engine may send the structured data and the future health state of each of the second set of IHSs to the distributor.

In Step 334, based on (i) the set of objectives, (ii) the future health state of each of the second set of IHSs and the structured data, and (iii) user-defined geographic restriction, the distributor analyzes the second set of IHSs to identify a fourth set of IHSs (within the first location) to deploy the workload.

In Step 336, based on Step 334, the distributor deploys the workload to an identified IHS of the fourth set of IHSs. In Step 338, after deploying the workload, the distributor obtains second real-time data of the identified IHS. In Step 340, by employing linear, non-linear, and/or ML models, the distributor analyzes the second real-time data of the identified IHS to infer, at least, (i) performance of the workload on the identified IHS and (ii) a current health state of the identified IHS.

In Step 342, based on Step 340, the distributor makes a sixth determination (in real-time or near real-time) as to whether the current health state of the identified IHS is critical (e.g., whether the identified IHS is unhealthy). Accordingly, in one or more embodiments, if the result of the sixth determination is YES, the method proceeds to Step 344. If the result of the sixth determination is NO, the method alternatively proceeds to Step 348.

In Step 344, as a result of the sixth determination in Step 342 being YES, the distributor migrates the workload from the identified IHS to another “healthy” identified IHS (e.g., a second IHS) within the first location. The distributor may migrate the workload to another “healthy” identified IHS to manage distribution of the workload across the fourth set of IHSs and to manage a temperature of an internal environment of the identified IHS.

In Step 346, in conjunction with the reporting module, the distributor initiates notification of the user, via the GUI of the client, to indicate that the workload is migrated from the identified IHS to another identified IHS (within the first location). In one or more embodiments, the method may end following Step 346.

In Step 348, as a result of the sixth determination in Step 342 being NO, the distributor makes a seventh determination (in real-time or near real-time) as to whether the workload's performance is below the predefined performance threshold. Accordingly, in one or more embodiments, if the result of the seventh determination is YES, the method returns to Step 344. If the result of the seventh determination is NO, the method alternatively proceeds to Step 350.

In Step 350, as a result of the seventh determination in Step 348 being NO, the distributor keeps the workload executing on the identified IHS until analyzing newer real-time data of the identified IHS (obtained at a later point-in-time after obtaining the second real-time health data in Step 338). Thereafter, in conjunction with the reporting module, the distributor initiates notification of the user, via the GUI of the client, to indicate that the workload is deployed to the identified IHS. In one or more embodiments, the method may end following Step 350.

### Start of Example

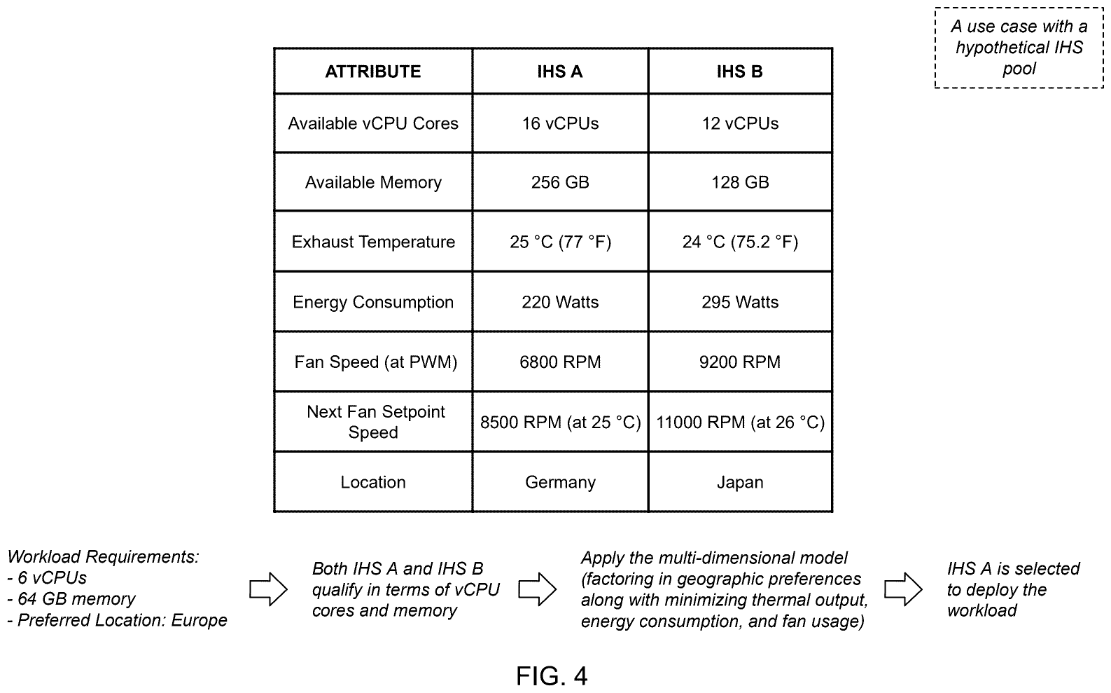

The following section describes an example of one or more embodiments. The example, illustrated in FIG. 4, is not intended to limit the scope of the embodiments disclosed herein and is independent from any other examples discussed in this application.

Turning now to FIG. 4, FIG. 4 shows a scenario with a hypothetical IHS pool, in which a user initiates a workload (by specifying one or more computing resource requirements to execute the workload). Based on that, the management module starts an IHS selection process in order to deploy the workload, in which the selection process includes: (i) pool selection ((a) the management module identifies a pool of candidate IHSs that meet the specified computing resource requirements for the workload and (b) IHSs that are lacking the requirements are automatically excluded), (ii) optimization-based selection (from the candidate pool, the management module selects one or more IHSs based on criteria aimed at minimizing energy consumption and optimizing thermal management, which involves considering: (a) the IHS with the lowest current power consumption, (b) the IHS demonstrating the lowest temperature, and (c) the IHS operating with the lowest fan speed), (iii) constraint consideration (the selection process incorporates various constraints, including user-defined geographic restrictions, ensuring a comprehensive optimization approach), and (iv) workload redistribution (if a workload exceeds an IHS' capacity, mechanisms are in place for adjusting the workload's execution-by slowing down, stopping, or relocating the workload as necessary). For the sake of brevity, not all processes performed by the management module may be discussed in FIG. 4.

Assume here that: (i) IHS A's attributes: (a) available vCPU cores: 16vCPUs, (b) available memory: 256 GB, (c) exhaust temperature: 25° C., (d) energy consumption: 220 Watts, (e) fan speed (at pulse with modulation (PWM)): 6800 revolutions per minute (RPM), (f) next fan setpoint speed: 8500 RPM (at 25° C.), and (g) location: Germany; and (ii) IHS B's attributes: (a) available vCPU cores: 12vCPUs, (b) available memory: 128 GB, (c) exhaust temperature: 24° C., (d) energy consumption: 295 Watts, (e) fan speed (at PWM): 9200 RPM, (f) next fan setpoint speed: 11000 RPM (at 26° C.), and (g) location: Japan; (iii) workload requirements (including computing resource requirements): 6 vCPUs, 64 GB memory, and preferred location: Europe.

Based on the aforementioned parameters, the management module starts the IHS selection process by identifying IHSs that meet the basic computing resource requirements of the workload: both IHS A and IHS B qualify in terms of vCPU cores and memory. The management module then applies its multi-dimensional optimization algorithm, factoring in geographic preferences alongside minimizing thermal output, energy consumption, and fan usage metrics.

To this end, the management module evaluates: (i) geographic alignment: only IHS A aligns with the geographic preference (Europe), making IHS A as the primary candidate, (ii) thermal efficiency: despite IHS A having a slightly higher exhaust temperature than IHS B, IHS A's overall thermal management strategy is more efficient, indicated by lower fan speed requirements to maintain optimal temperature thresholds, (iii) energy consumption: IHS A exhibits lower energy consumption (220 Watts) compared to IHS B (295 Watts), indicating a more energy-efficient operation that aligns with our the management module's optimization objectives, and (iv) fan speed and setpoints: IHS A operates at a lower current fan speed (6800 RPM) and has a lower next setpoint speed compared to IHS B, suggesting that IHS A can manage additional workload without significantly increasing cooling requirements or energy consumption.

Based on the management module's comprehensive evaluation, IHS A is selected for the workload. This selection is justified by IHS A's geographical compatibility, superior energy efficiency, and more favourable thermal management characteristics. Despite its marginally higher exhaust temperature, IHS A's lower energy consumption and fan speed requirements outweigh the minimal temperature difference. This decision exemplifies the management module's ability to make nuanced, multi-faceted optimization choices that balance performance, energy efficiency, and environmental impact considerations.

### End of Example

Turning now to FIG. 5, FIG. 5 shows a diagram of a computing device in accordance with one or more embodiments disclosed herein.

In one or more embodiments disclosed herein, the computing device (500) may include one or more computer processors (502), non-persistent storage (504) (e.g., volatile memory, such as RAM, cache memory), persistent storage (506) (e.g., a non-transitory computer readable medium, a hard disk, an optical drive such as a CD drive or a DVD drive, a Flash memory, etc.), a communication interface (512) (e.g., Bluetooth interface, infrared interface, network interface, optical interface, etc.), an input device(s) (510), an output device(s) (508), and numerous other elements (not shown) and functionalities. Each of these components is described below.

In one or more embodiments, the computer processor(s) (502) may be an integrated circuit for processing instructions. For example, the computer processor(s) (502) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (e.g., a LAN, a WAN, Internet, mobile network, etc.) and/or to another device, such as another computing device.

In one or more embodiments, the computing device (500) may include one or more output devices (508), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing a workload distribution, the method comprising:
receiving a workload deployment request from a user, wherein the request comprises information associated with a workload;
obtaining, in response to the request, real-time health data of a set of information handling systems (IHSs);
performing preprocessing on the real-time health data to obtain structured data;
analyzing, based on a hardware requirement (HR) specified in the information, the structured data to identify a second set of IHSs that satisfies the HR for the workload;
obtaining historical data associated with the second set of IHSs;
making, based on the information, a first determination that the information does not comprise a user-defined geographic restriction;
in response to the first determination, predicting, by employing a model and based on the structured data and the historical data, a future health state of each of the second set of IHSs, wherein the structured data comprises a current health state of each of the second set of IHSs;
analyzing, based on a set of objectives and the future health state of each of the second set of IHSs and the current health state of each of the second set of IHSs, the second set of IHSs to identify a third set of IHSs to deploy the workload;
deploying, based on the analyzing of the second set of IHSs, the workload to an IHS of the third set of IHSs;
after deploying the workload:
obtaining second real-time health data of the IHS;
analyzing the second real-time health data to infer a performance of the workload on the IHS and a second current health state of the IHS;
making, based on the analyzing of the second real-time health data, a second determination that the second current health state of the IHS is critical;
migrating, based on the second determination, the workload from the IHS to a second IHS of the third set of IHSs; and
initiating a notification of the user to indicate that the workload is migrated from the IHS to a second IHS.

2. The method of claim 1, wherein the information further specifies at least one selected from a group consisting of a hardware resource set comprising the HR that needs to be satisfied by a candidate IHS that is identified to host the workload, an operational requirement that needs to be satisfied by the candidate IHS, and a data compliance regulation that needs to be considered while identifying the candidate IHS.

3. The method of claim 1, wherein the workload is migrated to the second IHS to manage distribution of the workload across the third set of IHSs and to manage a temperature of an internal environment of the IHS.

4. The method of claim 1, wherein the real-time health data specifies at least one selected from a group consisting of a hardware resource set of the IHS, a number of workloads being executed by the second IHS, a current exhaust temperature of the first IHS, current energy consumption of the second IHS, a system log associated with the first IHS, an application log associated with the second IHS, an air intake amount of the first IHS, and location information of the first IHS.

5. The method of claim 4, wherein the hardware resource set specifies at least one selected from a group consisting of a minimum user count, a maximum user count, a swap space configuration, a reserved memory configuration, and a hardware virtualization configuration.

6. The method of claim 4, wherein the hardware resource set specifies at least one selected from a group consisting of a minimum user count, a maximum user count, a central processing unit (CPU) configuration, an input/output memory management unit configuration, and a type of a graphics processing unit (GPU) scheduling policy.

7. The method of claim 4,
wherein the first IHS is located in a first zone and the second IHS is located in a second zone,
wherein the first zone and the second zone are distinct zones, and
wherein the first zone is a first geographic region in the world and the second zone is a second geographic region in the world.

8. The method of claim 1, wherein the set of objectives dictates deploying the workload to a high performance and energy-efficient IHS within the second set of IHSs and thermally managing the second set of IHSs.

9. The method of claim 1,
wherein a second future health state of a third IHS has the highest probability to become the second future health state among a list of future health states associated with the third IHS, and
wherein the second future health state specifies at least a projected thermal condition of the third IHS and a number of workloads that is projected to be executed by the third IHS.

10. The method of claim 1, the model is a trained multi-objective optimization model.

11. A method for managing a workload distribution, the method comprising:
receiving a workload deployment request from a user, wherein the request comprises information associated with a workload;
obtaining, in response to the request, real-time health data of a set of information handling systems (IHSs);
performing preprocessing on the real-time health data to obtain structured data;
analyzing, based on a hardware requirement (HR) specified in the information, the structured data to identify a second set of IHSs that satisfies the HR for the workload;
obtaining historical data associated with the second set of IHSs;
making, based on the information, a first determination that the information comprises a user-defined geographic restriction, wherein the restriction specifies a deployment location for the workload;
making, based on the first determination, a second determination that the deployment location's temperature is below a temperature threshold;
based on the second determination, predicting, by employing a model and by considering the structured data and the historical data, a future health state of each of the second set of IHSs, wherein the structured data comprises a current health state of each of the second set of IHSs;
analyzing, based on a set of objectives, the restriction, and the future health state of each of the second set of IHSs and the current health state of each of the second set of IHSs, the second set of IHSs to identify a third set of IHSs within the location to deploy the workload;
deploying, based on the analyzing of the second set of IHSs, the workload to an IHS of the third set of IHSs;
after deploying the workload:
obtaining second real-time health data of the IHS;
analyzing the second real-time health data to infer a performance of the workload on the IHS and a second current health state of the IHS;
making, based on the analyzing of the second real-time health data, a third determination that the second current health state of the IHS is non-critical;
making, based on the third determination, a fourth determination that the performance of the workload is below a performance threshold;
migrating, based on the fourth determination, the workload from the IHS to a second IHS of the third set of IHSs; and
initiating a notification of the user to indicate that the workload is migrated from the IHS to a second IHS.

12. The method of claim 11, wherein the information further specifies at least one selected from a group consisting of a hardware resource set comprising the HR that needs to be satisfied by a candidate IHS that is identified to host the workload, an operational requirement that needs to be satisfied by the candidate IHS, and a data compliance regulation that needs to be considered while identifying the candidate IHS.

13. The method of claim 11, wherein the workload is migrated to the second IHS to manage distribution of the workload across the third set of IHSs and to manage a temperature of an internal environment of the IHS.

14. The method of claim 11, wherein the real-time health data specifies at least one selected from a group consisting of a hardware resource set of the IHS, a number of workloads being executed by the second IHS, a current exhaust temperature of the first IHS, current energy consumption of the second IHS, a system log associated with the first IHS, an application log associated with the second IHS, an air intake amount of the first IHS, and location information of the first IHS.

15. The method of claim 14, wherein the hardware resource set specifies at least one selected from a group consisting of a minimum user count, a maximum user count, a central processing unit (CPU) configuration, an input/output memory management unit configuration, and a type of a graphics processing unit (GPU) scheduling policy.

16. The method of claim 11, wherein the set of objectives dictates deploying the workload to a high performance and energy-efficient IHS within the second set of IHSs and thermally managing the second set of IHSs.

17. The method of claim 11,
wherein a second future health state of a third IHS has the highest probability to become the second future health state among a list of future health states associated with the third IHS, and
wherein the second future health state specifies at least a projected thermal condition of the third IHS and a number of workloads that is projected to be executed by the third IHS.

18. A method for managing a workload distribution, the method comprising:
receiving a workload deployment request from a user, wherein the request comprises information associated with a workload;
obtaining, in response to the request, real-time health data of a set of information handling systems (IHSs);
performing preprocessing on the real-time health data to obtain structured data;
analyzing, based on a hardware requirement (HR) specified in the information, the structured data to identify a second set of IHSs that satisfies the HR for the workload;
obtaining historical data associated with the second set of IHSs;
making, based on the information, a first determination that the information does not comprise a user-defined geographic restriction;
in response to the first determination, predicting, by employing a model and based on the structured data and the historical data, a future health state of each of the second set of IHSs, wherein the structured data comprises a current health state of each of the second set of IHSs;
analyzing, based on a set of objectives and the future health state of each of the second set of IHSs and the current health state of each of the second set of IHSs, the second set of IHSs to identify a third set of IHSs to deploy the workload;
deploying, based on the analyzing of the second set of IHSs, the workload to an IHS of the third set of IHSs;
after deploying the workload:
obtaining second real-time health data of the IHS;
analyzing the second real-time health data to infer a performance of the workload on the IHS and a second current health state of the IHS;
making, based on the analyzing of the second real-time health data, a second determination that the second current health state of the IHS is non-critical;
making, based on the second determination, a third determination that the performance of the workload is not below a performance threshold; and
keeping, based on the third determination, the workload on the IHS.

19. The method of claim 18, wherein the information further specifies at least one selected from a group consisting of a hardware resource set comprising the HR that needs to be satisfied by a candidate IHS that is identified to host the workload, an operational requirement that needs to be satisfied by the candidate IHS, and a data compliance regulation that needs to be considered while identifying the candidate IHS.

20. The method of claim 18, wherein the real-time health data specifies at least one selected from a group consisting of a hardware resource set of the IHS, a number of workloads being executed by the second IHS, a current exhaust temperature of the first IHS, current energy consumption of the second IHS, a system log associated with the first IHS, an application log associated with the second IHS, an air intake amount of the first IHS, and location information of the first IHS.
